(19) United States
(12) Patent Application Publication
(10) Pub. No.: US 2010/0241530 A1
(43) Pub. Date: Sep. 23, 2010

(54) INTERACTIVE JOB CHART

(76) Inventor: Greggory Murset, Queen Creek, AZ (US)

Correspondence Address: SCHMEISER OLSEN & WATTS, 18 E UNIVERSITY DRIVE, SUITE # 101, MESA, AZ, 85201, US

(21) Appl. No.: 12/729,122

(22) Filed: Mar. 22, 2010

Related U.S. Application Data
(60) Provisional application No. 61/162,581, filed on Mar. 23, 2009.

(51) Int. Cl. G06Q 30/00; G06F 17/30

(52) U.S. Cl. 705/27; 707/792; 715/764; 707/E17.005

(57) ABSTRACT

A machine for tracking job completion is disclosed. The machine for tacking job completion includes a software program installed on a memory that is coupled to a microprocessor. The software instructs the microprocessor to store data assigned to participants, jobs and rewards. In a particular embodiment the participants are children and jobs are assigned to them by their parents. Children can earn points by completing jobs. Children can trade the earned points for rewards. Parents use the assigned jobs and the rewards available to teach responsibility and work ethic, and to accurately track job completion and reward allowance.

### CROSS REFERENCE TO RELATED APPLICATION[S]

This application claims priority to U.S. Provisional Patent Application to Greggory T. Murset entitled “Interactive Job Chart Systems” Ser. No. 61/162,581, filed Mar. 23, 2009, the disclosure of which is hereby incorporated entirely herein by reference.

### BACKGROUND OF THE INVENTION

1. Technical Field

The present invention relates generally to the field of task logging and more specifically relates to a machine for tracking job completion.

2. State of the Art

Parents delegate many tasks to their children as a means for teaching and for instilling a sense of responsibility, work ethic and accountability in them as they grow towards maturity. Many of the tasks are single work events and others are designed to aid in the learning process on an on-going basis. Problems may exist in tracking these tasks and/or events over a period of time. Further, the tasks when accomplished may not be accurately recorded showing a direct relationship between the work accomplished and the reward earned.

Task management methods and systems are known for planning, scheduling and control within organizations, such as those described in U.S. Pat. Nos. 6,445,986, 6,101,481, 5,016,170, 5,893,074, 6,223,201, and 6,035278. Programs such as Microsoft Project are currently employed to assist project managers in developing plans, assigning resources to tasks, tracking progress, managing budgets and analyzing workloads. Programs such as these are efficient for use with projects and task management, however are complex and not user-friendly for laymen and especially children. These task management systems also fail to directly correlate task completion with reward. Another need that has not been addressed by the current programs is the ability to permit personable interaction and communication between parents and children on an informal basis.

Ideally, a job tracking system should be convenient and fun to use for parents and children. The system should be accessible, and provide a progress tracking means using a task/reward correlation that is customizable to the child. Thus, a need exists for a user-friendly job tracking machine to avoid the above-mentioned problems.

### DISCLOSURE OF THE INVENTION

The present invention relates to the field of task logging and more specifically relates to a machine for tracking job completion. The machine according to the invention includes a processor, a memory, and a software program stored on the memory and operated by the processor. The software tool includes a participant list containing participant names. Associated with each participant name is participant profile data. The participant profile data includes an earned point value and a job list. The job list contains a list of names assigned to the participant. Each job name has job data assigned to it, the job data comprising a job point value and a job completion indicator, wherein the job completion indicator indicates whether the job has been completed or not. The software program also includes a job completion credit utility and a user interface utility. The job completion credit utility adds the job point value to the earned point value in response to the job completion indicator indicating that the job is complete. The user interface utility is coupled to an input/output device, and allows users of the software program to interact with the software program. In some embodiments the participant data also includes a rewards purchased list, a reward shopping cart list, and reward data. The rewards purchase list is a list of reward names purchased by the participant. The reward shopping cart list contains a reward name. The reward data contains data assigned to the reward name. The reward data includes a reward point value and a reward purchase indicator. The reward purchase indicator indicates whether purchase of the reward name is to be executed or not. In some embodiments the software program includes a reward purchase utility. The reward purchase utility places the reward name on the reward purchased list, removes the reward name from the shopping cart list, and subtracts the reward point value from the earned point value in response to the reward purchase indicator indicating that purchase of the reward name is to be executed. In some embodiments the reward purchase utility is linked to store websites to allow purchase of store items. In some embodiments the software program includes a calendar utility which adds job names to the job list according to a predetermined calendar schedule. In some embodiments the job data includes a job due date that is the date that the job is to be completed by. In some embodiments bonus points are added to the earned point value in response to the job being completed a predetermined amount of time prior to the job due date.

The invention discloses a memory with an executable software program stored on the memory. The software program instructs a microprocessor to perform a number of steps including storing participant profile data assigned to a participant name, wherein the participant profile data includes an earned point value and a job list. The job list includes a job name. The software program instructs the microprocessor to store job data assigned to the job name. The job data includes a job point value and a job completion indicator. The job completion indicator indicates whether the job has been completed or not. The software program instructs the microprocessor to perform crediting of job completion by performing the job completion step of adding the job point value to the earned point value in response to the job name having a job completion indicator indicating the job name is complete. In some embodiments the job completion steps include sending an email to a predetermined email address to report job completion. In some embodiments the participant profile data also includes a rewards purchased list and a reward shopping cart list which includes a reward name. In some embodiments the microprocessor is instructed to perform the steps of storing reward data assigned to the reward name. The reward data include a reward point value and a reward purchase indicator. The reward purchase indicator indicates whether purchase is to be executed or not. In some embodiments the microprocessor is instructed to perform purchasing of a reward by performing reward purchase steps in response to the reward purchase indicator indicating that reward purchase is to be executed. The reward purchase steps include subtracting the reward point value from the earned point value, adding the reward name to the rewards purchased list, and removing the reward name from the reward shopping cart list. In some embodiments the reward purchase steps include sending an email to a predetermined email address to report reward purchase. In some embodiments the software program instructs the microprocessor to perform providing a participant interface tool, wherein the participant interface tool allows a user of the software program that is associated with the participant name to interact with predetermined participant profile data. In some embodiments the software program instructs the microprocessor to perform providing an administrator interface tool, wherein the administrator interface tool allows an administrator of the software program to define the participant name and interact with all of the participant profile data.

A method of tracking job completion is disclosed which includes the steps of storing participant profile data, storing job data, storing reward data, crediting completion of a job, and purchasing a reward. In some embodiments participant profile data includes an earned points value, and a job list, wherein the job list comprises a job name. In some embodiments participant profile data includes a rewards purchased list, and a reward shopping cart list, where in the reward shopping cart list comprises a reward name.

In some embodiments the job data includes a job point value and a job completion indicator, wherein the job completion indicator indicates whether the job name has been completed or not. In some embodiments the reward data comprises a reward point value, wherein the reward point value is a number, and a reward purchase indicator, wherein the reward purchase indicator indicates whether purchase of the reward name is to be executed or not. In some embodiments crediting completion of a job comprises adding the job point value to the earned point value in response to the job completion indicator indicating that the job name has been completed. In some embodiments purchasing a reward comprises subtracting the reward point value from the earned point value, adding the reward name to the rewards purchased list, and removing the reward name from the reward shopping cart list in response to the reward purchase indicator indicating that purchase of the reward name is to be executed.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a perspective view of one embodiment of machine 101 for tracking job completion according to the invention.

FIG. 2 is a block diagram of machine 101 for tracking job completion of FIG. 1.

FIG. 3 is a block diagram showing an embodiment of participant list 142 and participant profile data 120 which are part of software program 102 of machine 101 for tracking job completion.

FIG. 4 is a flow chart showing operation of one embodiment of job completion credit utility 160 which is part of software program 102 of machine 101 for tracking job completion of FIG. 1.

FIG. 5 is a block diagram showing participant list 142 and participant profile data 120 of FIG. 3 after job completion indicator 158 has been modified to reflect job completion, but before the job completion credit utility 160 has been executed.

FIG. 6 is a block diagram showing participant list 142 and participant profile data 144 of FIG. 5 after job completion credit utility 160 has been executed.

FIG. 7 is a flow chart showing operation of one embodiment of reward purchase utility 320 which is part of software program 102 of the machine 101 for tracking job completion of FIG. 1.

FIG. 8 is a block diagram showing participant list 142 and participant profile data 120 of FIG. 6 after reward purchase indicator 180 has been modified to request purchase execution, but before reward purchase utility 320 has been executed.

FIG. 9 is a block diagram showing participant list 142 and participant profile data 120 of FIG. 8 after reward purchase utility 320 has been executed.

FIG. 10 is one embodiment of user interface screen 163 created by the user interface utility of machine 101 for tracking job completion according to the invention. This user interface screen can be used by a participant to view job list 150 and record job completion.

FIG. 11 is another embodiment of user interface screen 163 created by the user interface utility of machine 101 for tracking job completion according to the invention. This user interface screen can be used by a participant to view reward shopping cart list 172 and purchase rewards.

FIG. 12 is a further embodiment of user interface screen 163 created by the user interface utility of machine 101 for tracking job completion according to the invention. This user interface screen can be used by an administrator to create participant list 142 and assign participant profile data 120 to participant name 144.

FIG. 13 shows method 300 of tracking job completion according to the invention.

### DETAILED DESCRIPTION OF EMBODIMENTS OF THE INVENTION

As discussed above, embodiments of the present invention relate to a machine for tracking job completion, also known as a job chart. In particular embodiments the invention forms an interactive job chart system incorporating task logging for children.

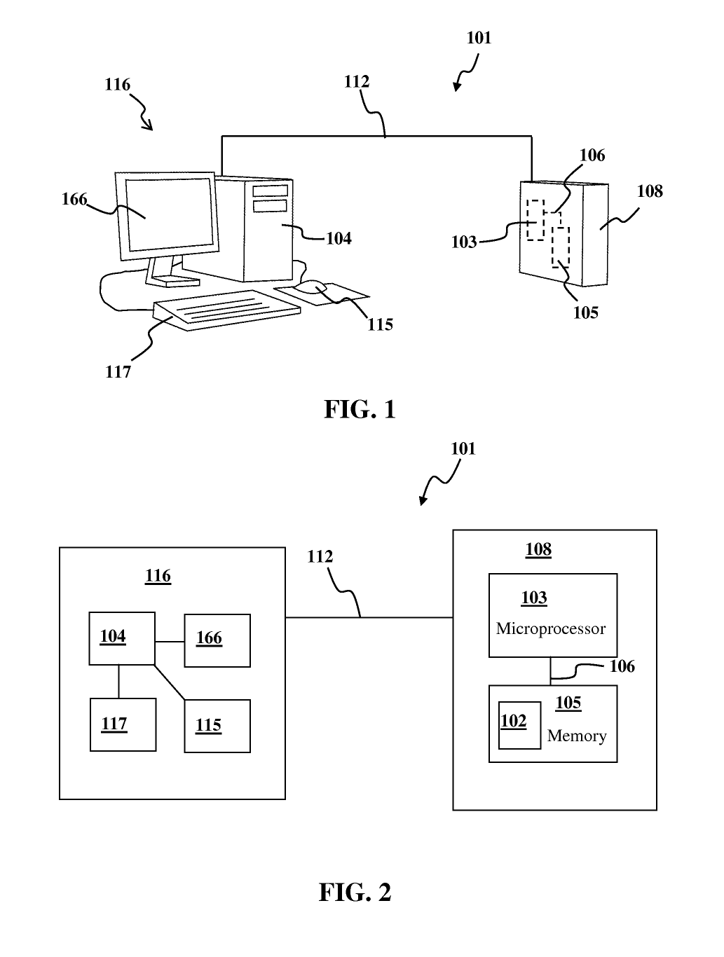

As shown in FIG. 1 and FIG. 2, the machine for tracking job completion 101 according to the invention includes microprocessor 103 coupled to memory 105. Software program 102 is installed on memory 105 and operated using microprocessor 103. Memory 105 and microprocessor 103 are part of server 108 in this embodiment. In some embodiments memory 105 and microprocessor 103 are part of devices other than a server. Software program 102 includes a user interface utility coupled to input/output (I/O) device 116 through interconnect 112. I/O device 116 provides a means for users to interact with software program 102. Interacting with software program 102 includes providing input and viewing output from software program 102 as is true generally with software programs in use today. FIG. 1 shows a perspective view one embodiment of machine 101 according to the invention, and FIG. 2 shows a block diagram of machine 101 of FIG. 1. In the embodiment shown in FIG. 1, microprocessor 103 and memory 105 are part of server 108. I/O device 116 is coupled to server 108, and therefore to microprocessor 103, memory 105, and software program 102 through connection 112. I/O device 116 includes computer 104, monitor 166, keyboard 117, and mouse 115 in this embodiment.

The embodiment of machine 101 according to the invention shown in FIG. 1 and FIG. 2 illustrates a desktop computer as I/O device 116 connected via interconnect 112 to server 108. Interconnect 112 in this embodiment is an internet connection which is coupling I/O device 116 to server 108. In this way a user of software program 102 can interact with software program 102 by using a desktop computer as I/O device 116. Many other embodiments are possible of machine 101 according to the invention. In some embodiments microprocessor 103 and memory 105 can be part of a home computer such as a desktop or laptop computer. In some embodiments microprocessor 103 and memory 105 can be part of a mobile computer. In some embodiments microprocessor 103 and memory 105 can be part of a mobile phone such as a cellular phone. In some embodiments microprocessor 103 and memory 105 can be part of a personal digital assistant (PDA). In some embodiments microprocessor 103 and memory 105 can be part of another device capable of coupling microprocessor 103 and memory 105 to connection 112. In some embodiments connection 112 is an internet connection. In some embodiments connection 112 is a network connection such as a local area network or a wireless area network. In some embodiment connection 112 is a Bluetooth connection. In some embodiments connection 112 is a USB cable or a monitor interface cable. In some embodiments connection 112 is a cellular phone network. In some embodiments connection 112 is another means for coupling a computer to an input device. In some embodiments connection 112 is another means for coupling a computer to an output device.

I/O device 116 can take many different forms according to the invention. As shown in FIG. 1, I/O device 116 can be a computer connected to the internet. In some embodiments I/O device 116 is a monitor and a keyboard and a mouse. In some embodiments I/O device 116 is a monitor. In some embodiments I/O device 116 is a keyboard. In some embodiments I/O device 116 includes a touch device. In some embodiments I/O device 116 is a cellular phone. In some embodiments I/O device 116 includes a digital camera. In some embodiments I/O device 116 is a personal digital assistant. In some embodiments I/O device 116 is any device adapted to interface with a computer. In some embodiments I/O device 116 is any device adapted to interface with a network.

Machine 101 according to the invention is used to track completion of jobs. Software program 102 of machine 101 is used to create a list of participants. Participants are assigned jobs to perform. An administrator creates participant lists and assigns participant profile data to each participant name. The administrator or administrators assigns jobs, and in general sets up software program 102. Participants view the jobs they are assigned, record completion of the jobs, earn points for job completion, and trade the points for rewards. In the embodiment of machine 101 described in this document, the participants are children and the administrator is a parent or parents. This embodiment will be discussed in more detail throughout this document. It is to be understood, however, that participants can be other users besides children and administrators can be other users besides parents. In some embodiments participants are students and administrators are teachers. In some embodiments participants are disabled children or adults, and the administrator is a caretaker. In some embodiments participants are Sunday school children and the administrator is a Sunday school teacher. Many different forms are possible for machine 101 for tracking job completion.

Machine for tracking job completion 101 is used in the embodiment described in this document as an efficient means for parents to assign jobs to children in order to build work ethic, to teach responsibility and to communicate with their children using technology and positive reinforcement. The parent or guardian may register their child as a participant on machine for tracking job completion 101 using software program 102 and creating an individualized profile for the child(ren). The parent or guardian may input jobs to be assigned to the child through his/her profile within the framework of software program 102, according to the age and ability of the child. Jobs may be assigned a value on a point system that may be traded for rewards.

The child logs onto software program 102 each day to view the assigned jobs and log completion of the jobs. During the process the child may be encouraged in these jobs by the parent sending personalized notes of encouragement which can be accessed from a computer, cellular phone or PDA. The child completes the jobs and as each job is completed the child records job completion and accumulates the assigned point values. Upon successful completion of jobs or reward redemption a message may be sent to the parent's cellular phone or computer in the form of an email or text message.

The accumulated points may be traded for rewards that may include family time, movie nights, computer time, game time and other such rewards. The parent and child can determine what rewards that the child wants to work towards. When a reward is claimed, the points are deducted on the points accumulation display to coincide with the redemption. In some embodiments reward points can be converted to a monetary value, and the child can use the monetary value to make a deposit to a bank account, contribute to charity, or purchase store items. The reward store may be linked to ebay, itunes, gift card venders, or other such sites to redeem products. Target marketing may also be utilized within the reward store based upon the age and gender of the child.

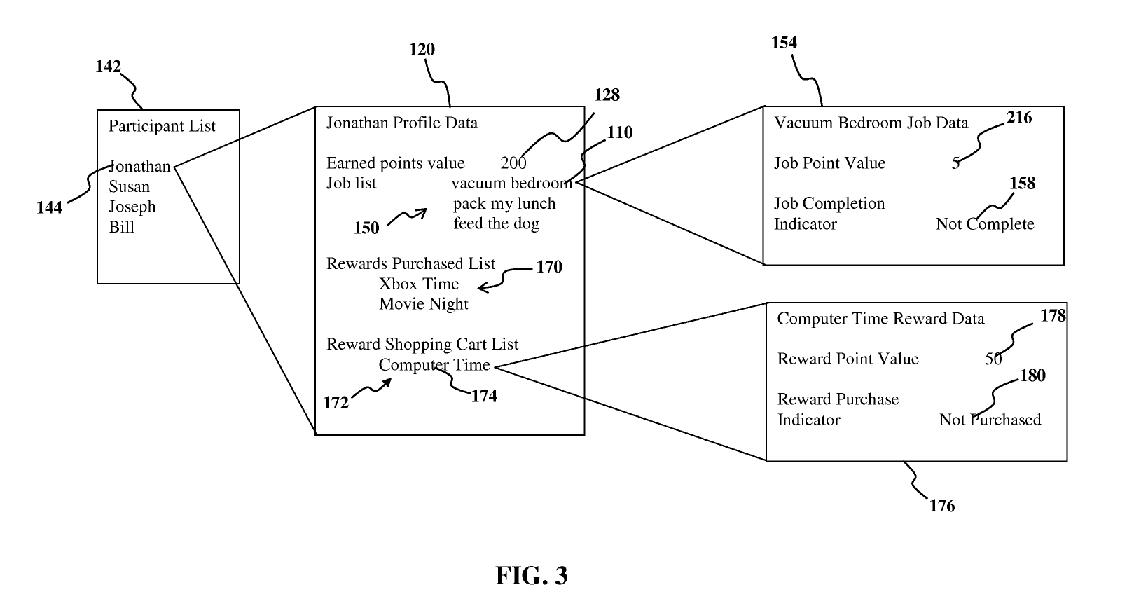

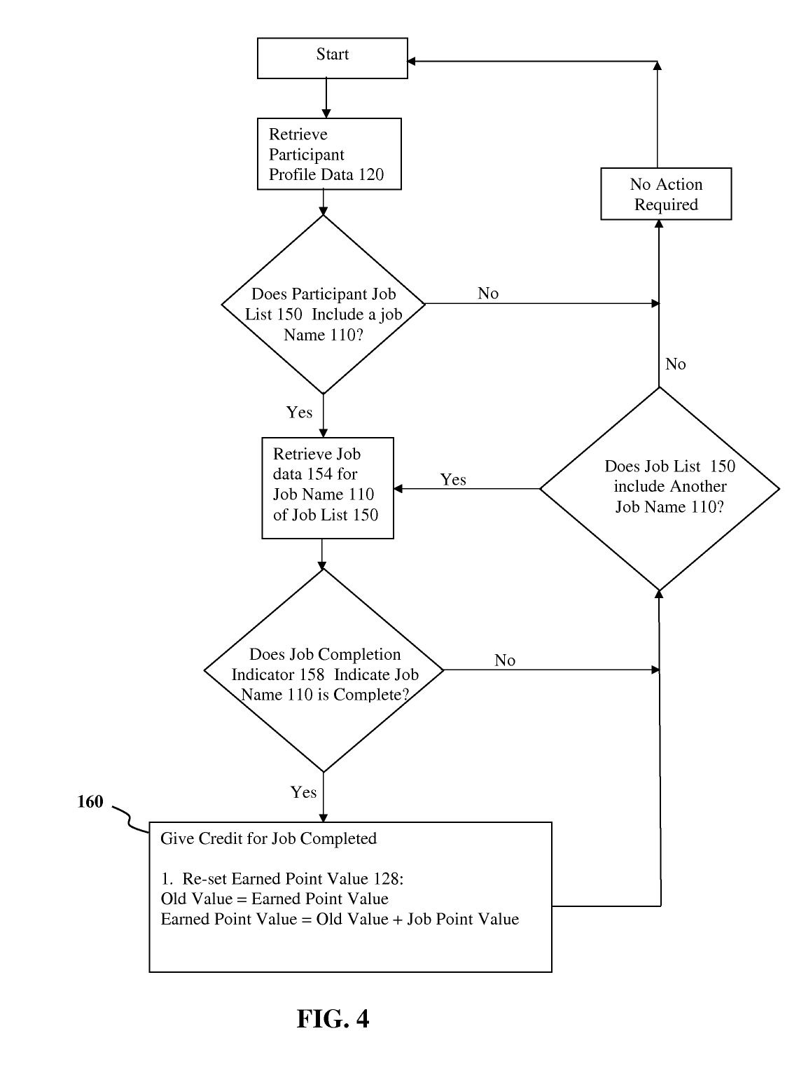

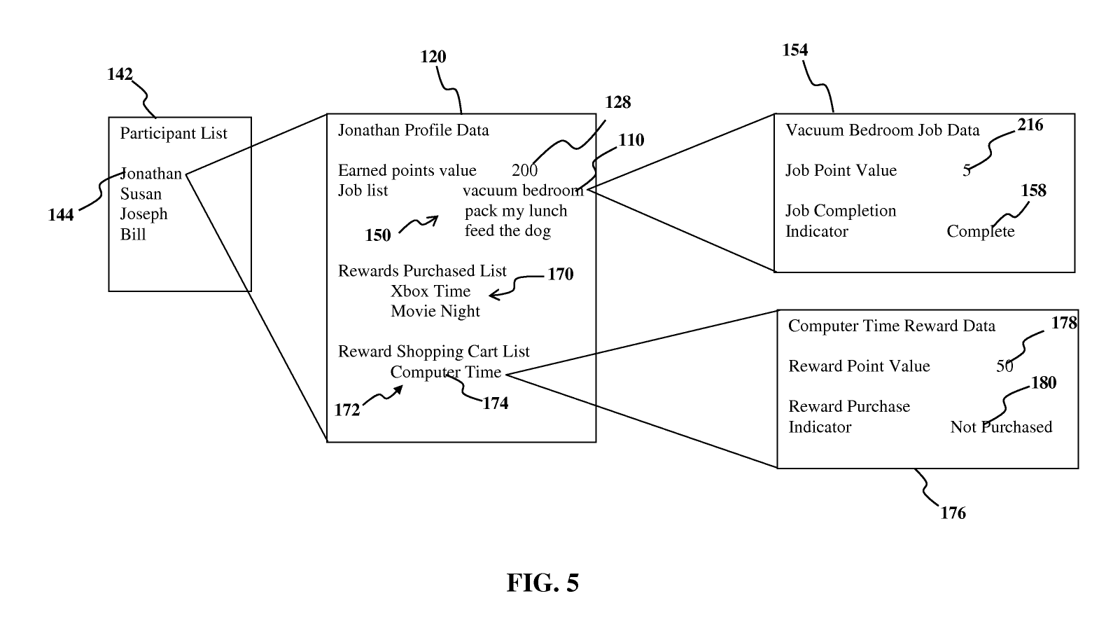

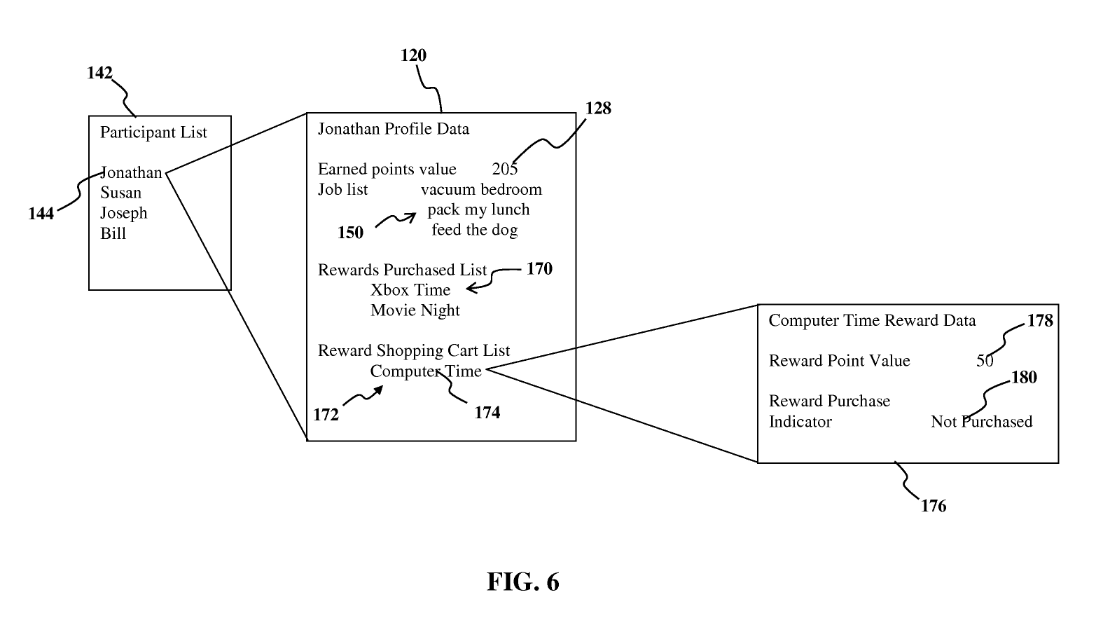

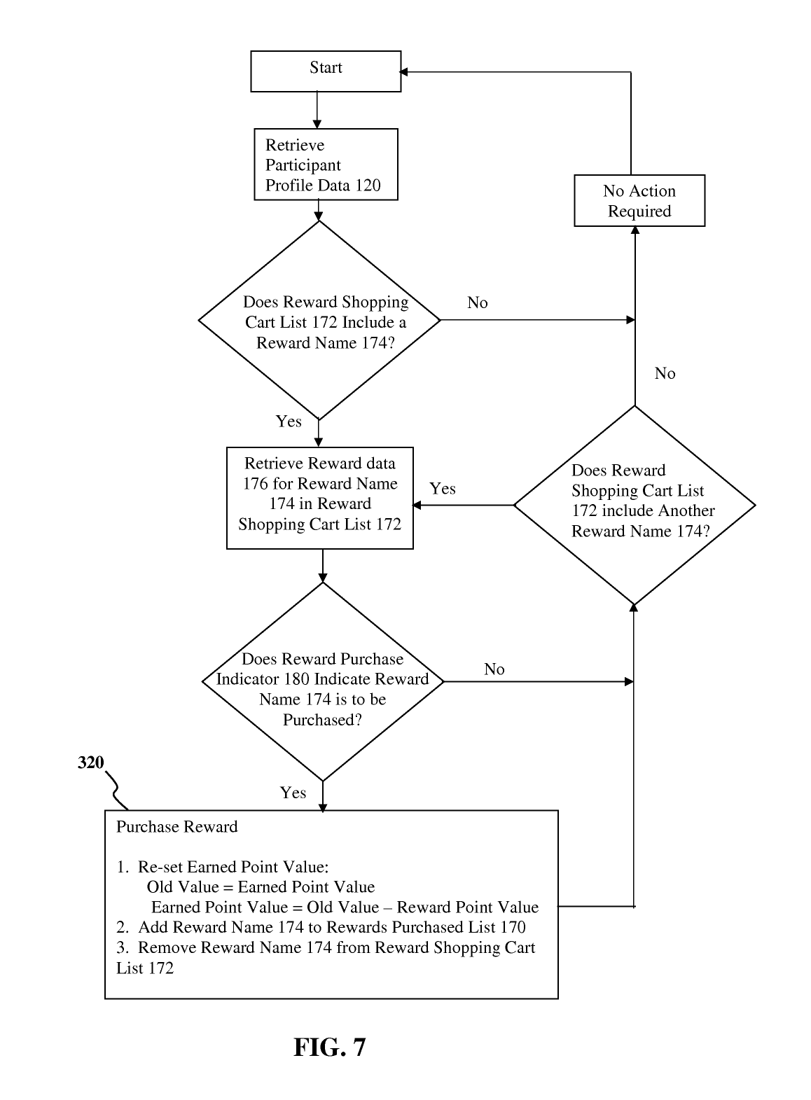

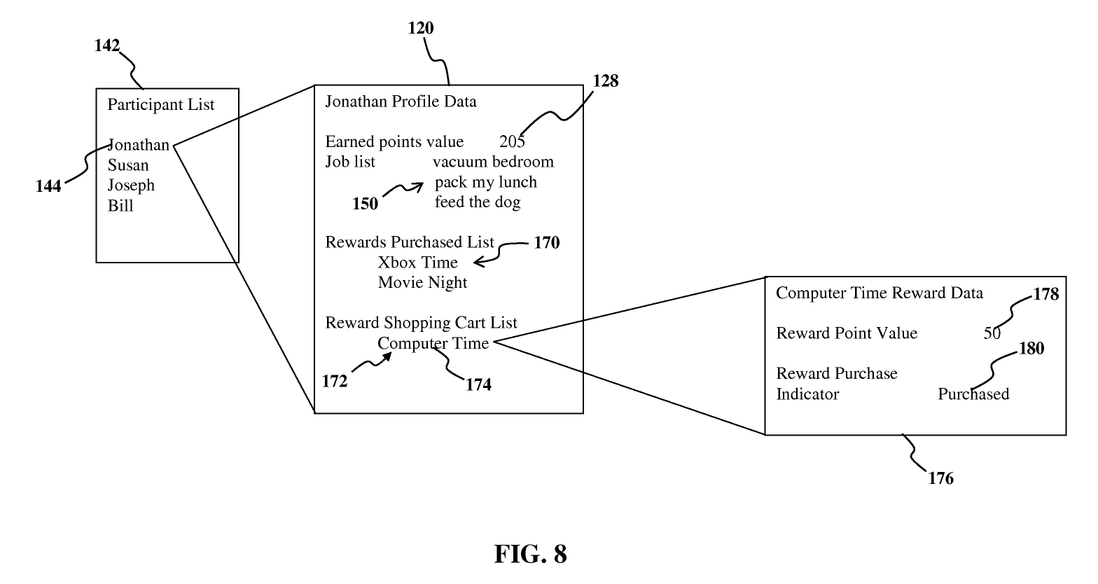

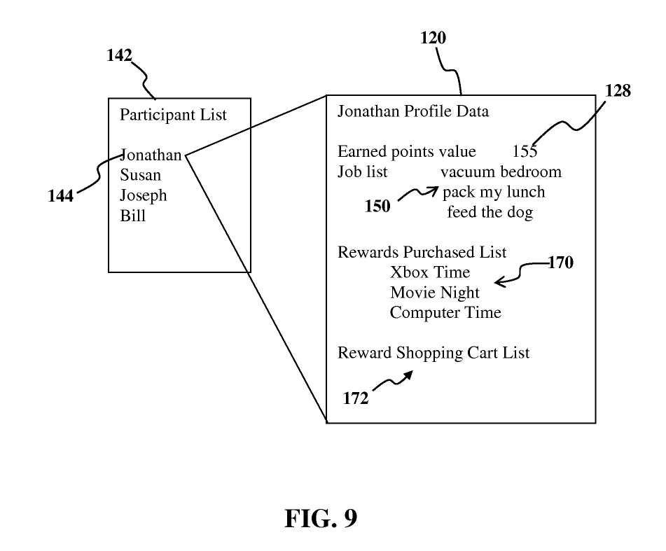

FIG. 3 through FIG. 9 show details of the operation of software program 102. FIG. 3 is a block diagram showing a snapshot of some of the data stored as participant profile data 120 as created and used by software program 102 in this embodiment. FIG. 4 is a flowchart including job completion credit utility 160, which is part of software program 102. FIG. 5 is the data of FIG. 3 after job completion indicator 158 has been modified to indicate a job name is complete. FIG. 6 is the data of FIG. 5 after job completion utility 160 has been executed to give the participant credit for completion of the job. FIG. 7 is a flowchart including reward purchase utility 320, which is part of software program 102. FIG. 8 is the data of FIG. 6 after purchase indicator 180 has been modified to indicate purchase of the reward name is to be executed. FIG. 9 is the data of FIG. 8 after reward purchase utility 320 has been executed to purchase the reward name for the participant.

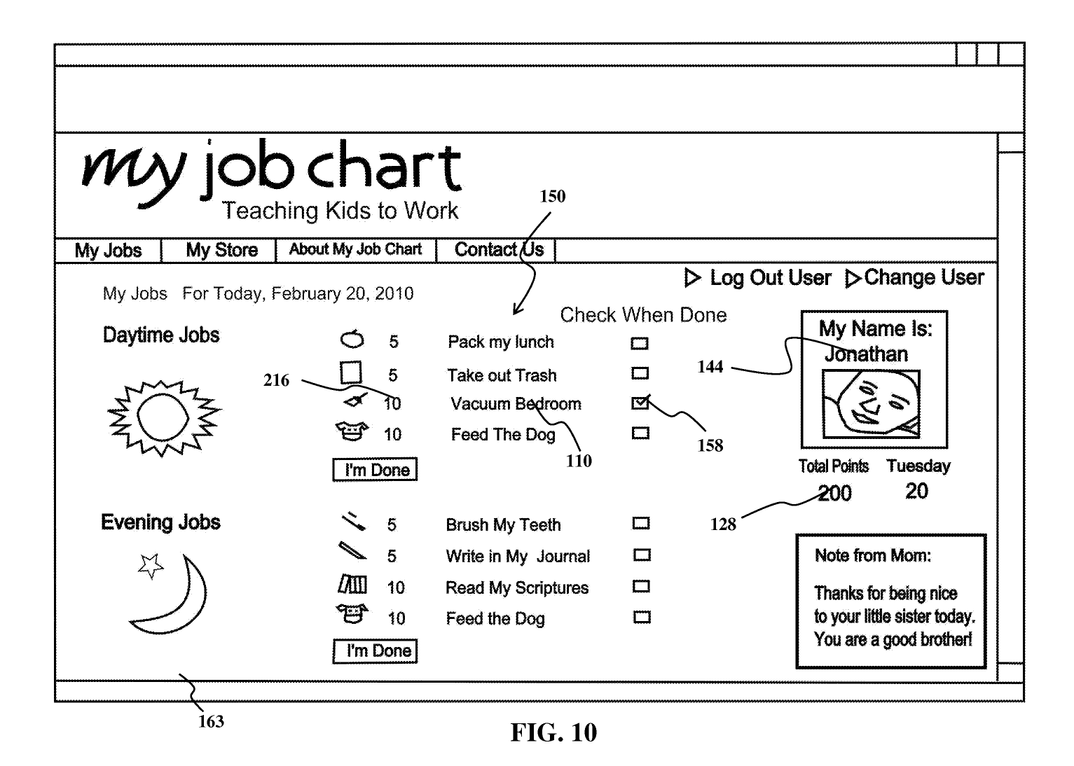

Software program 102 includes participant list 142 as shown in FIG. 3. Participant list 142 includes a participant name. This means that participant list 142 includes one or more than one participant names. In this embodiment the participant names are names of children that are entered by a parent. Participant list 142 as shown in FIG. 3 includes participant name 144 corresponding to child “Jonathan”. Software program 102 includes participant profile data 120. Participant profile data 120 includes data assigned to participant name 144 Jonathan. Participant profile data 120 includes an earned point value 128. Earned points value 128 is a number which represents the number of points that Jonathan has earned so far. In this embodiment Jonathan has an earned point value 128 that is equal to 200 points. Participant profile data 120 also includes a job list 150. Job list 150 is a list of jobs that have been assigned to Jonathan by his parent. Job list 150 includes a job name. This means that job list 120 includes one or more than one job name. Job list 150 in this embodiment includes job name 110 “vacuum bedroom”. Job name 110 has job data 154 assigned to it by software program 102. Job data 154 includes job point value 216 and job completion indicator 158. Job point value 216 is a number which is the number of points that Jonathan will earn if he completes job name 110 “vacuum bedroom”. In this embodiment job point value 216 for job name 110 vacuum bedroom is equal to 5 points. This means that Jonathan will earn 5 points when he completes and records completion of job name 110 vacuum bedroom. Job completion indicator 158 is an indicator which can be in one of two states. One state represents that the job is not complete. The other state represents that the job is complete. In this way job completion indicator 158 indicates whether a job has been completed or not. Jonathan utilizes a user interface utility which is part of software program 102 to interface to software program 102. FIG. 10 shows one embodiment of a user interface screen 163 created by the user interface utility and interacted with by Jonathan using keyboard 117 and mouse 115. In this way Jonathan not only learns to track and complete jobs and earn points, he is also learning to use and interact with a computer program. Jonathan sees that his job list 150 includes job name 110 vacuum bedroom. Jonathan goes off to vacuum his bedroom. Then Jonathan modifies job completion indicator 158 to indicate that job name 110 vacuum bedroom is complete.

Software program 102 includes job completion credit utility 160. Job completion credit utility 160 is invoked by software program 102 when a job completion indicator 158 is changed to indicate a job is complete, as shown by the flow chart in FIG. 4. Software program 102 monitors participant profile data 120 assigned to each participant name 144. When job completion indicator 158 for job name 110 on job list 150 indicates that a job has been completed, job completion credit utility 160 adds job point value 216 to earned points value 128. For example, FIG. 3 indicates the status of some of the data in participant profile data 120 for participant name 144 Jonathan before he has completed job name 110 vacuum bedroom. Job completion indicator 158 for vacuum bedroom indicates the job is not complete. Jonathan has an earned points value 128 of 200 points and can earn 5 more points for vacuuming his bedroom. FIG. 5 shows the status of data in participant profile data 120 for participant name 144 Jonathan after Jonathan has completed job name 110 vacuum bedroom but before job completion credit utility 160 has given him credit for the job. Job completion indicator 158 indicates job 110 vacuum bedroom has been completed. FIG. 6 shows the status of data in participant profile data 120 for Jonathan after the job completion credit utility 160 has given Jonathan credit for job name 110 vacuum bedroom. Earned points value 128 is now equal to 205 points after job point value 5 for job name 110 vacuum bedroom was added to the old earned points value of 200 points. Jonathan has completed the job vacuuming his bedroom and has received credit points for doing this job. In this way job completion credit utility 160 adds job point value 216 to earned point value 128 in response to job completion indicator 180 indicating that job name 110 is complete. In some embodiments the steps performed in response to job completion indicator 158 indicating the job is complete includes sending an email to a predetermined email address to report job completion. In this way machine 101 for tracking job completion shows Jonathan clearly how completing jobs results in his earned point value 128 increasing. There is a relationship between doing a job and earning points for completion of the job. In some embodiments of the invention the parent can communicate an encouraging message to Jonathan as another reward received for job completion.

Software program 102 stored on memory 102 has instructed microprocessor 103 to track job completion of Jonathan's job by performing certain steps. These steps include storing participant profile data 120 assigned to participant name 144. Participant profile data 120 includes earned points value 128 and job list 150 which includes job name 110. The steps microprocessor 103 is instructed to perform by software program 102 includes storing job data 154 assigned to job name 110. Job data 154 includes job point value 216 and job completion indicator 158. A further step microprocessor 103 is instructed to perform by software program 102 is crediting completion of job name 110 in response to job name 110 having job completion indicator 158 indicate that job name 110 is complete. Crediting completion of job name 110 includes the step of adding job point value 216 to earned point value 128. In some embodiments crediting completion of job name 110 includes the step of sending an email to a predetermined email address reporting completion of job name 110.

Software program 102 also allows Jonathan to purchase rewards using the points he has earned completing jobs. As illustrated in FIG. 6, participant profile data 120 for Jonathan includes rewards purchased list 170. Rewards purchased list 170 is a list of all of the rewards Jonathan has purchased already. Participant profile data 120 also includes reward shopping cart list 172. Reward shopping cart list includes a reward name 174. Reward shopping cart list 172 is a list of the rewards Jonathan is considering purchasing, and can include one or more than one reward name. In this embodiment reward shopping cart list 172 contains reward name 174 “computer time”. Reward name 174 computer time has reward data 176 assigned to it. Reward data 176 includes reward point value 178. Reward point value 178 is the number of points needed to purchase the computer time reward. In this embodiment reward point value 178 for computer time is 50 points. Reward data 176 also includes a reward purchase indicator 180 which indicates whether purchase of reward name 174 is to be executed or not. Reward purchase indicator 180 can have one of two states. One state indicates that purchase of reward name 174 is not to be executed, which is state “not purchased”. The other state indicates that the purchase of reward name 174 is to be executed, which is state “purchased”. Jonathan can add reward names to his reward shopping cart list 172, but purchase of them will not be executed until Jonathan modifies reward purchase indicator 180 for a reward name 174 from “not purchased” to “purchased”.

Software program 102 includes reward purchase utility 320. Reward purchase utility 320 is invoked by software program 102 when reward purchase indicator 180 is changed to indicate purchase of reward name 174 is to be executed, as shown in the flowchart of FIG. 7. Software program 102 monitors participant profile data 120 for each participant name 144. When reward purchase indicator 180 for a reward name on reward shopping cart list 172 indicates that a reward purchase is to be executed, reward purchase utility 320 performs several steps, as shown in FIG. 7. These steps include subtracting reward point value 178 from earned point value 128, adding reward name 174 to rewards purchased list 170, and removing reward name 174 from reward shopping cart list 172. For example, FIG. 6 indicates the status of some of the data in participant profile 120 for participant Jonathan before he has executed the purchase of reward name 174 “computer time”. Reward purchase indicator 180 for computer time indicates that the purchase is not to be executed. Jonathan has an earned points value 128 of 205 points and it will cost him 50 points to purchase computer time. FIG. 8 shows the status of the data in participant profile data 120 for participant Jonathan after he has decided to execute the purchase of reward name 174 computer time but before reward purchase utility 320 has executed his purchase. Reward purchase indicator 180 indicates purchase of reward 110 computer time is to be executed. FIG. 9 shows the status of some of the data in participant profile data 120 for Jonathan after reward purchase utility 320 has executed purchase of reward name 174 computer time. Earned point value 128 is now equal to 155 points after reward point value 178, which is worth 50 points for reward name 174 computer time, was subtracted from the old earned point value 128 of 205 points. Reward name 174 computer time has been added to rewards purchased list 170. And reward name 174 computer time has been removed from reward shopping cart list 172. Jonathan has completed purchase of reward name 174 computer time using 50 of his earned points. In this way machine 101 for tracking job completion has taught Jonathan how to earn and use points. In this way reward purchase utility 320 places reward name 174 on rewards purchase list 170, removes reward name 174 from reward shopping cart list 172, and subtracts reward point value 178 from earned point value 128 in response to reward purchase indicator 180 indicating that purchase of reward name 174 is to be executed. In some embodiments the steps performed by reward purchase utility 320 in response to reward purchase indictor 180 indicating reward name 174 computer time is to be purchased includes sending an email to a predetermined email address to report purchase of reward name 174. In this way purchase of the reward will be reported to Jonathan's parent.

Software program 102 stored on memory 102 has instructed microprocessor 103 to purchase rewards by Jonathan by performing the steps of storing participant profile data 120 assigned to participant name 144, wherein participant profile data 120 includes rewards purchase list 170 and reward shopping cart list 172. Reward shopping cart list 172 includes reward name 174. The steps further include storing reward data 176 assigned to reward name 174. Reward data 176 includes reward point value 178 and reward purchase indicator 180. Microprocessor 103 is instructed by software 102 to perform purchasing of a reward by performing several steps in response to reward purchase indicator 180 indicating that reward name 174 is to be purchased. These steps include subtracting reward point value 178 from earned point value 128, adding reward name 174 to rewards purchased list 170, and removing reward name 174 from reward shopping cart list 172. In some embodiments of software program 102 the steps microprocessor 103 is instructed to perform in response to reward purchase indicator 180 indicating reward name 174 is to be purchased includes sending an email to a predetermined email address to report purchase of reward name 174.

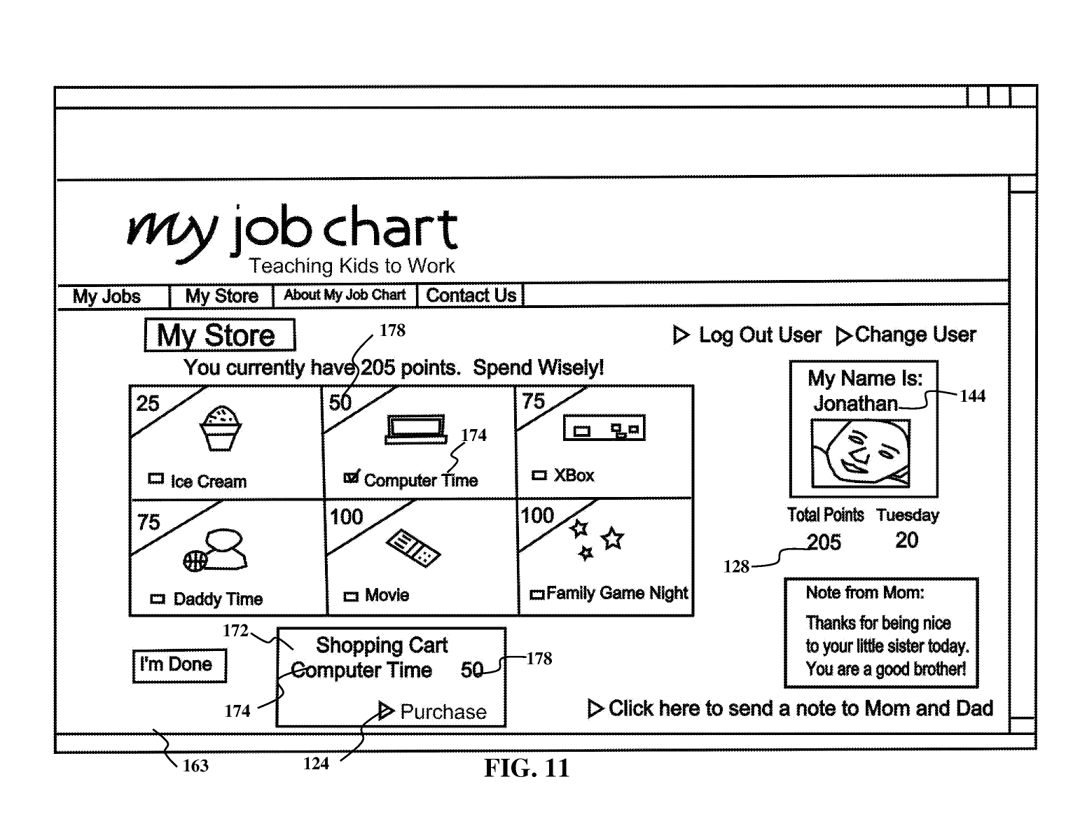

FIG. 11 shows one embodiment of user interface image 163 created by the user interface utility of software program 102 and displayed on output device 166. User interface image 163 is interacted with by participant Jonathan using keyboard 117 and mouse 115 (see FIG. 1). In some embodiments particpants interact with software program 102 using other interface devices. Jonathan can see that he has 205 earned points, and can view the list of rewards that are available for purchase. Each reward name 174 has a corresponding reward point value 178. Jonathan can add reward names to his reward shopping cart list 172, and change reward purchase indicator 180 from “not purchased” to “purchased” using icon 124 when he is ready to execute purchase of a reward name 174. The rewards on Jonathan's reward list are chosen by an administrator, in this embodiment Jonathan's parent. The parent can assign rewards to the reward list appropriate for Jonathan's age, gender, abilities, interests, and personality. The parent also defines how many points to assign to each reward name 174. In this way Jonathan is able to work to earn rewards he values and to see the tangible results of his work.

Jonathan is able to view and interface with some, but not all, of his participant user profile data 120. Jonathan is not able to assign himself jobs or add his name to the participant list, or assign job point values 216 to his jobs. Jonathan is not able to create rewards or add rewards to the reward he has available to purchase, or to assign reward point values 178 to the rewards. Only his parent, the administrator, is allowed to modify this data. Jonathan can see his job list 150 (FIG. 10), record job completion, and purchase rewards from a reward list. Software program 102 uses microprocessor 103 to provide a participant interface utility which creates user interface images 163 such as those shown in FIG. 10 and FIG. 11 to allow Jonathan to interface with software program 102 and interact with some of his participant profile data 120. In this way software program 102 instructs microprocessor 103 to provide a participant interface tool which allows Jonathan access to predetermined parts of his participant profile data 120.

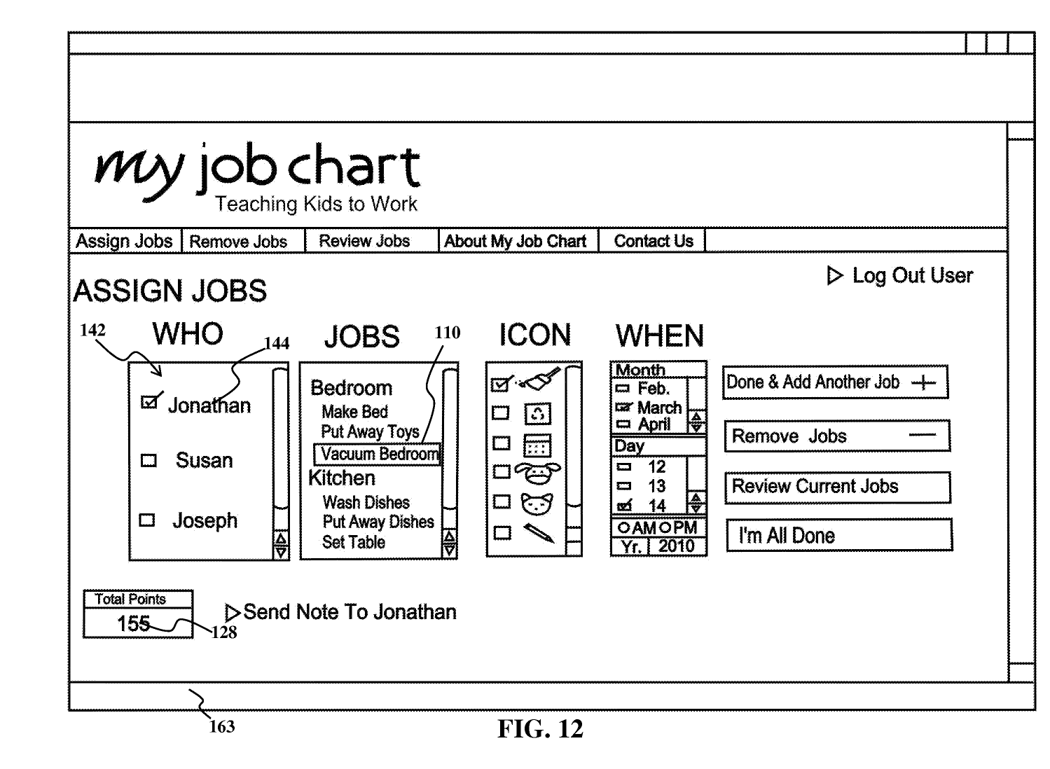

FIG. 12 shows an embodiment of user interface image 163 created by the user interface utility of software program 102 for allowing an administrator to interface with all of the participant profile data 120. An administrator, in this embodiment Jonathan's parent, is able to create participant list 142, create participant names 144, and create and modify participant profile data 120. In this way software program 102 instructs microprocessor 103 to provide an administrator interface tool which allows Jonathan's parent to define participant names, and create and interact with all of participant profile data 120.

It is to be understood that many other forms of user interface image 163 are possible. Image can be created in many forms and used by participants or administrators to interact with software program 102. In some embodiments user interface image 163 can include motivational and informational images for Jonathan.

In some embodiments machine 101 with software program 102 according to the invention includes a job calendar utility. The job calendar utility can be programmed by the administrator or parent to add job names to a participant job list 150 according to a certain calendar schedule. For example, Jonathan's parent can set the job calendar utility to add the job name “brush teeth” to Jonathan's job list 150 every day. There may be other jobs that Jonathan needs to do daily, such as feed the dog, which can also be added to Jonathan's list on a daily basis. Other jobs, such as vacuum bedroom, might only need to be done every week. Jonathan's parents can use the job calendar utility to have the job name 110 vacuum bedroom be added to Jonathan's job list 150 every week. There may be other jobs which only have to be done monthly, or every few months. The job calendar utility allows jobs to be added to job lists according to a calendar schedule specific to each job name. In this way software program 102 includes a job calendar utility which adds job names 110 to job list 150 according to a predetermined calendar schedule.

In some embodiments of software program 102, job data 154 includes a job due date. The job due date is the date and time job name 110 is to be completed by. The job due date will help Jonathan know how much time he has to complete a job. In some embodiments of the invention, Jonathan can earn bonus points, which are added to earned point value 128, by completing a job a predetermined amount of time before the due date. For example, the job vacuum bedroom might have a due date of one week. If Jonathan finishes vacuuming his bedroom in one week he will earn 5 points. But, Jonathan's parent can set up software program 102 such that for each day early that Jonathan completes vacuuming his bedroom, he will earn 1 extra point. So if Jonathan completes vacuuming his bedroom 2 days early, he can earn 7 points (5 points for job completion, 2 points for completed 2 days early). In this way bonus points are added to earned point value 128 in response to job completion occurring a predetermined amount of time before the job due date. In some embodiments of software program 102, bonus points are earned by a participant by completing a predetermined number of tasks within a predetermined amount of time. In some embodiments bonus points are earned when earned point value 128 reaches a predetermined number.

In some embodiments of software program 102, the job due date can be used to penalize Jonathan for jobs completed late. Continuing the further example, the job vacuum bedroom can be set up by Jonathan's parent using software program 102 so that for every day he is late in completing the job, he loses 1 earned point value. In this way Jonathan learns not only that he can earn value by completing jobs, but that there is a penalty for not completing jobs on time. This teaches scheduling and prioritizing skills In this way penalty points are subtracted from the earned points value in response to completion occurring after the job due date.

In some embodiments of software program 102 earned point value 128 can be converted to a monetary amount. The participant can be provided choices as to what they would like to do with the monetary amount. The choices can include making a deposit to a bank or other financial institution, contributing to charity, or making a purchase of store items. In some embodiments the rewards list can be linked to store websites so that participants can choose store products as rewards. Many other choices can be provided as to what to do with reward points or monetary amounts depending on the specific participant. In some embodiments the participant can choose to invest a monetary amount. In some embodiments the monetary amount can be used for a college fund or for paying bills. It is to be understood, however, that in some embodiments the earned point value does not correspond to a monetary amount, and the rewards purchased do not correspond to commercial items. In the embodiment discussed in this document, Jonathan is learning the value of working to accomplish a reward. But he is also learning that money is not always what is earned, and that money is not always what is important, and that some rewards cannot be bought with money. Jonathan and his parent create a reward list for Jonathan that allows Jonathan to earn items that are important to him, such as time playing a sport, family time, or a chance to take a trip to a favorite place. In this way earned points are not related to monetary values and rewards purchased are not commercial items purchased with money. Software program 102 allows the jobs performed, and the rewards purchased to be customized to the needs of the participant.

In some embodiments of software program 102 job data 154 can include information helpful to job completion, such as the location of cleaning products, instructions on how to use cleaning machines, or encouraging notes from an administrator. In this way Jonathan's parents can provide information and encouragement for Jonathan to use in completing his jobs. In some embodiments of software program 102 participants and administrators can send secure messages back and forth. Jonathan may want to ask questions of his parent. The parent may want to encourage or thank Joanathan. In this way program 102 provides secure communication means between a participant and an administrator.

It is to be understood that many different I/O devices 116 can be a part of machine 101 for tracking job completion. I/O device 116 can be or include any computer, keyboard, mouse, touch screen, pointer, Wii device, digital camera, cellphone, PDA, or any other computing or communication device. This allows participants and administrators to interact with machine 101 and each other from local or remote locations, at school, at home, at work, while traveling, etc.

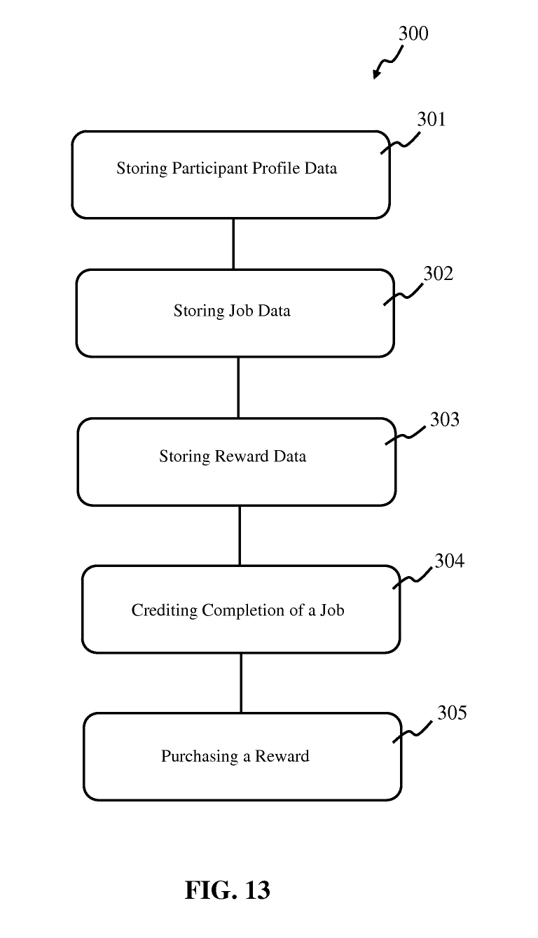

FIG. 13 illustrates a computer performed method 300 of tracking job completion according to the invention which includes step 301 storing participant profile data, step 302 storing job data, step 303 storing reward data, step 304 crediting completion of a job, and step 305 purchasing a reward. Method 300 can include many other steps. In some embodiments method 300 includes the step of providing a participant interface tool which allows a participant access to predetermined portions of the participant profile data. In some embodiments method 300 includes the step of providing an administrator interface tool which allows an administrator to define a participant name and allows an administrator access to all of the participant profile data.

Step 301 storing participant profile data includes storing participant profile data assigned to a participant name. The participant profile data includes an earned points value which is a number representing the number of points earned by the participant name. The participant profile data includes a job list, wherein the job list includes a job name. The participant profile data includes a rewards purchased list and a reward shopping cart list. The reward shopping cart list can contain a reward name.

Step 302 storing job data includes storing job data assigned to the job name. The job data includes a job point value, which is a number representing the number of points earned by completing the job name. The job data includes a job completion indicator, which indicates whether the job name has been completed or not completed.

Step 303 storing reward data includes storing data assigned to the reward name. The reward data includes a reward point value, which is a number representing the number of points needed to purchase the reward name. The reward data also includes a reward purchase indicator, which indicates whether purchase of the reward name is to be executed or not.

Step 304 crediting completion of a job includes adding the job point value to the earned point value in response to the job completion indicator indicating that the job name has been completed. In some embodiments Step 304 includes sending an email to a predetermined email address to report job completion.

Step 305 purchasing a reward includes subtracting the reward point value from the earned point value, adding the reward name to the rewards purchased list, and removing the reward name from the reward shopping cart list in response to the reward purchase indicator indicating that purchase of the reward name is to be executed. In some embodiments step 305 includes sending an email to a predetermined email address to report purchase of the reward name.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. For example, software program 102 can be used by businesses and sports teams to track job completion.

1. A machine for tracking job completion comprising:
a microprocessor coupled to a memory; and
a software program installable on the memory and operated by using the microprocessor,
the software program comprising:
a participant list, wherein the participant list comprises a participant name;
a participant profile data, wherein the participant profile data contains data assigned to the participant name, the participant profile data comprising:
an earned point value, wherein the earned point value is a number;
a job list, wherein the job list comprises a job name; and
a job data, wherein the job data contains data assigned to the job name, the job data comprising:
a job point value, wherein the job point value is a number; and
a job completion indicator, wherein the job completion indicator indicates whether the job name has been completed or not;
a job completion credit utility, wherein the job completion credit utility adds the job point value to the earned point value in response to the job completion indicator indicating that the job name has been completed; and
a user interface utility coupled to an input/output device, wherein the user interface utility allows a user of the software program to interact with the software using the input/output device.

2. The machine of claim 1, wherein the participant profile data further comprises:
a rewards purchased list;
a reward shopping cart list, wherein the reward shopping cart list includes a reward name; and
a reward data, wherein the reward data contains data assigned to the reward name,
the reward data comprising:
a reward point value, wherein the reward point value is a number; and
a reward purchase indicator, wherein the reward purchase indicator indicates whether purchase of the reward name is to be executed or not; and
wherein the software tool further comprises:
a reward purchase utility, wherein the reward purchase utility places the reward name on the reward purchase list, removes the reward name from the reward shopping cart list, and subtracts the reward point value from the earned point value in response to the reward purchase indicator indicating that purchase of the reward name is to be executed.

3. The machine of claim 1, wherein the software program further comprises:
a job calendar utility, wherein the job calendar utility adds job names to the job list according to a predetermined calendar schedule.

4. The machine of claim 1, wherein the job data comprises a job due date.

5. The machine of claim 1, wherein bonus points are added to the earned point value in response to job completion occurring a predetermined amount of time before the job due date.

6. The machine of claim 2, wherein the reward purchase utility is linked to a store website, allowing purchase of predetermined items from the store.

7. The machine of claim 1, wherein the user interface is coupled to the input/output device using the internet.

8. A memory with an executable software program stored thereon, wherein the software program instructs a microprocessor to perform the following steps:
storing participant profile data assigned to a participant name, wherein the participant profile data comprises:
an earned points value, wherein the earned points value is a number; and
a job list, wherein the job list comprises a job name;
storing job data assigned to the job name, wherein the job data comprises:
a job point value, wherein the job point value is a number; and
a job completion indicator, wherein the job completion indicator indicates whether the job name has been completed or not completed; and
crediting completion of the job name by performing the step of adding the job point value to the earned point value in response to the job name having a job completion indicator which indicates that the job name has been completed.

9. The memory with an executable software program stored thereon of claim 8, wherein the participant profile data further comprises:
a rewards purchased list; and
a reward shopping cart list, wherein the reward shopping cart list comprises a reward name; and
wherein the microprocessor is further instructed to perform the following steps:
storing reward data assigned to the reward name, wherein the reward data comprises:
a reward point value, wherein the reward point value is a number; and
a reward purchase indicator, wherein the reward purchase indicator indicates whether purchase of the reward name is to be executed or not executed; and
purchasing the reward name by performing the following steps in response to the purchase indicator indicating that purchase of the reward name is to be executed:
subtracting the reward point value from the earned point value;
adding the reward name to the rewards purchased list; and
removing the reward name from the reward shopping cart list.

10. The memory with an executable software program stored thereon of claim 8, wherein crediting completion of the job name further comprises the step of sending an email to a predetermined email address to report job completion.

11. The memory with an executable software program stored thereon of claim 9, wherein purchasing the reward name further comprises the step of sending an email to a predetermined email address to report reward purchase.

12. The memory with an executable software program stored thereon of claim 9, wherein the software program further instructs the microprocessor to perform the step of providing a participant interface tool, wherein the participant interface tool allows a user associated with the participant name to interact with predetermined participant profile data.

13. The memory with an executable software program stored thereon of claim 12, wherein the software program further instructs the microprocessor to perform the step of providing an administrator interface tool, wherein the administrator interface tool allows an administrator to define the participant name and interact with all of the participant profile data.

14. The memory with an executable software program stored thereon of claim 13, wherein the administrator interface tool allows the administrator to interact with the participant data through the internet.

15. A computer performed method of tracking job completion comprising:
storing participant profile data;
storing job data, wherein the job data is assigned to a job name;
storing reward data, wherein the reward data is assigned to a reward name;
crediting completion of a job; and
purchasing a reward.

16. The method of claim 15, wherein participant profile data comprises:
an earned points value;
a job list, wherein the job list comprises the job name;
a rewards purchased list, and
a reward shopping cart list, wherein the reward shopping cart list comprises the reward name.

17. The method of claim 16, wherein the job data comprises:
a job point value; and
a job completion indicator, wherein the job completion indicator indicates whether the job name has been completed or not.

18. The method of claim 17, wherein reward data comprises:
a reward point value, wherein the reward point value is a number, and
a reward purchase indicator, wherein the reward purchase indicator indicates whether purchase of the reward name is to be executed or not.

19. The method of claim 18, wherein crediting completion of a job comprises adding the job point value to the earned point value in response to the job completion indicator indicating that the job name has been completed.

20. The method of claim 19, wherein purchasing a reward comprises subtracting the reward point value from the earned point value, adding the reward name to the rewards purchased list, and removing the reward name from the reward shopping cart list in response to the reward purchase indicator indicating that purchase of the reward name is to be executed.
